(19) United States
(12) Patent Application Publication
(10) Pub. No.: US 2025/0245852 A1
(43) Pub. Date: Jul. 31, 2025

(54) SYSTEM AND METHOD OF COORDINATE SYSTEM ALIGNMENT FOR MULTIPLE HEAD MOUNTED DISPLAYS

(71) Applicant: HTC Corporation, Taoyuan City (TW)

(72) Inventors: Ying-Wen Chen, Taoyuan City (TW); Chih-An Tsao, Taoyuan City (TW)

(73) Assignee: HTC Corporation, Taoyuan City (TW)

(21) Appl. No.: 18/422,026

(22) Filed: Jan. 25, 2024

(51) Int. Cl. G06T 7/73; G06T 7/33; G06V 40/16

(52) U.S. Cl. CPC G06T 7/74; G06T 7/337; G06V 40/161; G06T 2207/30201

(57) ABSTRACT

A system and a method of coordinate system alignment for multiple head mounted displays are provided. The method includes: capturing a first image of a second head mounted display by a first camera of a first head mounted display; performing a first face detection on the first image to obtain a first bounding box corresponding to a first coordinate system by the first head mounted display; aligning the first coordinate system corresponding to the first head mounted display with a second coordinates system corresponding to the second head mounted display according to a first position of the first bounding box by the first head mounted display, so as to update the first coordinate system; and displaying an output image according to the updated first coordinate system by the first head mounted display.

### BACKGROUND

### Technical Field

The disclosure relates to extended reality (XR) technology, and particularly relates to a system and a method of coordinate system alignment for multiple head mounted displays (HMD).

### Description of Related Art

To perform coordinate system alignment for multiple HMDs, people often use a third-party object as a reference object. The HMDs may perform the coordinate system alignment by capturing images of the same reference object. However, in order to execute the method mentioned above, each HMD needs to be pre-configured with information of the reference object. That is, the type or location of the reference object cannot be freely changed. Therefore, the conventional approach may not be convenient in some circumstances.

### SUMMARY

The present invention is directed to a system and a method of coordinate system alignment for multiple HMDs.

The present invention is directed to a system of coordinate system alignment for multiple head mounted displays. The system includes first head mounted display and a second head mounted display. The first head mounted display includes a first camera, wherein the first head mounted display is configured to: capture a first image of the second head mounted display by the first camera; perform a first face detection on the first image to obtain a first bounding box corresponding to a first coordinate system; align the first coordinate system corresponding to the first head mounted display with a second coordinate system corresponding to the second head mounted display according to a first position of the first bounding box, so as to update the first coordinate system; and display an output image according to the updated first coordinate system.

In one embodiment of the present invention, the second head mounted display includes a second camera, wherein the second head mounted display is communicatively connected to the first head mounted display and is configured to: capture a second image of the first head mounted display by the second camera; perform a second face detection on the second image to obtain a second bounding box corresponding to the second coordinate system; and transmit information to the first head mounted display, wherein the information is associated with a second position of the second bounding box.

In one embodiment of the present invention, the first head mounted display aligns the first coordinate system with the second coordinate system according to the information.

In one embodiment of the present invention, the information includes a difference between the second position and a third position of the second head mounted display.

In one embodiment of the present invention, the first head mounted display is further configured to: obtain a coordinate of the first bounding box; and calculate the first position according to the coordinate, an inverse matrix of an intrinsic matrix of the first camera, and an inverse matrix of an extrinsic matrix of the first camera.

In one embodiment of the present invention, the first head mounted display is further configured to: capture a plurality of images by the first camera; and perform a simultaneous localization and mapping algorithm according to the plurality of images to obtain the extrinsic matrix.

In one embodiment of the present invention, the first head mounted display is further configured to: obtain depth information of the first head mounted display by the first camera; and calculate the first position according to the depth information.

In one embodiment of the present invention, the first head mounted display further includes a distance sensor and the first head mounted display is further configured to: obtain depth information of the first head mounted display by the distance sensor; and calculate the first position according to the depth information.

The present invention is directed to a method of coordinate system alignment for multiple head mounted displays, including: capturing a first image of a second head mounted display by a first camera of a first head mounted display; performing a first face detection on the first image to obtain a first bounding box corresponding to a first coordinate system by the first head mounted display; aligning the first coordinate system corresponding to the first head mounted display with a second coordinates system corresponding to the second head mounted display according to a first position of the first bounding box by the first head mounted display, so as to update the first coordinate system; and displaying an output image according to the updated first coordinate system by the first head mounted display.

In one embodiment of present invention, the method further including: capturing a second image of the first head mounted display by a second camera of a second head mounted display, wherein the second head mounted display is communicatively connected to the first head mounted display; performing a second face detection on the second image to obtain a second bounding box corresponding to the second coordinate system by the second head mounted display; and transmitting information to the first head mounted display by the second head mounted display, wherein the information is associated with a second position of the second bounding box.

In one embodiment of present invention, the first head mounted display aligns the first coordinate system with the second coordinate system according to the information.

In one embodiment of present invention, the information includes a difference between the second position and a third position of the second head mounted display.

In one embodiment of present invention, the method, further including: obtaining a coordinate of the first bounding box by the first head mounted display; and calculating the first position according to the coordinate, an inverse matrix of an intrinsic matrix of the first camera, and an inverse matrix of an extrinsic matrix of the first camera by the first head mounted display.

In one embodiment of present invention, the method further including: capturing a plurality of images by the first camera; and performing a simultaneous localization and mapping algorithm according to the plurality of image to obtain the extrinsic matrix by the first head mounted display.

In one embodiment of present invention, the method further including: obtaining depth information of the first head mounted display by the first camera; and calculating the first position according to the depth information by the first head mounted display.

In one embodiment of present invention, the method further including: obtaining depth information of the first head mounted display by a distance sensor of the first head mounted display; and calculating the first position according to the depth information by the first head mounted display.

Based on the above, the system of the present invention provides a way to align the coordinate systems of multiple HMDs by just gazing each other.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of system of coordinate system alignment for multiple HMDs according to one embodiment of the present invention.

FIG. 2 illustrates a flowchart of a method of coordinate system alignment for multiple HMDs according to one embodiment of the present invention.

FIG. 3 illustrates a schematic diagram of face detection according to one embodiment of the present invention.

FIG. 4 illustrates a flowchart of a method of coordinate system alignment for multiple HMDs according to one embodiment of the present invention.

### DESCRIPTION OF THE EMBODIMENTS

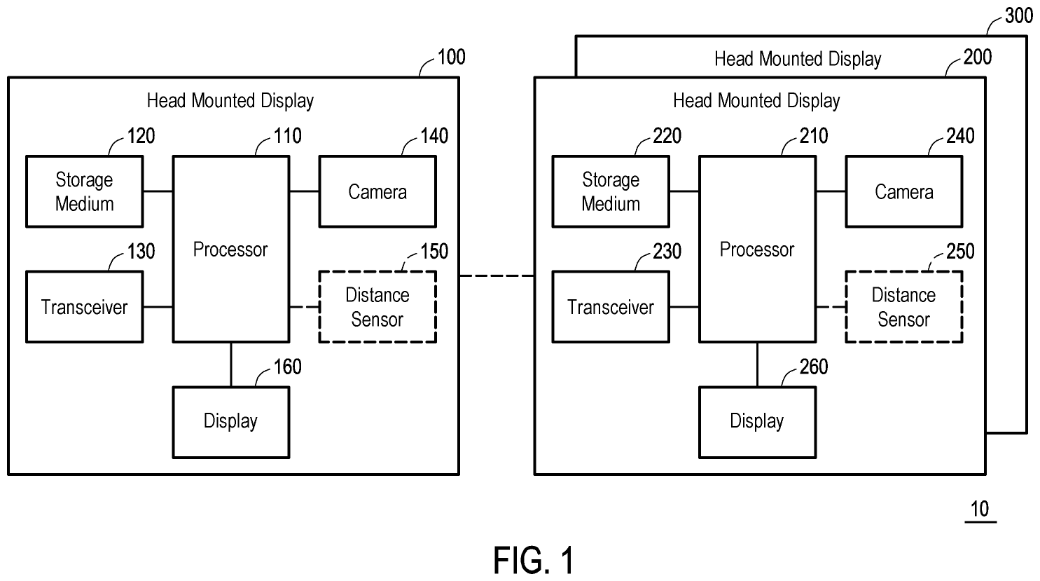

FIG. 1 illustrates a schematic diagram of system 10 of coordinate system alignment for multiple HMDs according to one embodiment of the present invention, wherein the system 10 may be implemented in an XR system (e.g., virtual reality (VR) system, augmented reality (AR) system, or mixed reality (MR) system). The system 10 may include a plurality of HMDs including HMD 100, HMD 200, and HMD 300. Each of the plurality of HMDs may have the same or similar hardware or software and may perform the same or similar functions. One of the plurality of HMDs may be a host HMD, the others may be guest HMDs. For example, the HMD 100 may be a host HMD, and the HMD 200 or HMD 300 may be a guest HMD. The guest HMD may align its own camera coordinate system with the camera coordinate system of the host HMD.

The HMD 100 may include a processor 110, a storage medium 120, a transceiver 130, a camera 140, and a display 160. In one embodiment, the HMD 100 may further include a distance sensor 150. The processor 110 may be, for example, a central processing unit (CPU) or other programmable micro control units (MCU) for general purpose or special purpose, a microprocessor, a digital signal processor (DSP), a programmable controller, an application specific integrated circuit (ASIC), a graphics processing unit (GPU), an arithmetic logic unit (ALU), a complex programmable logic device (CPLD), a field programmable gate array (FPGA), or other similar device or a combination of the above devices. The processor 110 may be coupled to the storage medium 120, the transceiver 130, the camera 140, the distance sensor 150, and the display 160.

The storage medium 120 may be, for example, any type of fixed or removable random access memory (RAM), a read-only memory (ROM), a flash memory, a hard disk drive (HDD), a solid state drive (SSD) or similar element, or a combination thereof, configured to record a plurality of modules or various applications executable by the processor 110.

The transceiver 130 may be configured to transmit or receive wired or wireless signals. The transceiver 130 may also perform operations such as low noise amplifying, impedance matching, frequency mixing, up or down frequency conversion, filtering, amplifying, and so forth. The HMD 100 may communicate with the HMD 200 or HMD 300 via the transceiver 130.

The camera 140 may be a photographic device for capturing images. The camera 140 may include an image sensor such as a complementary metal oxide semiconductor (CMOS) sensor or a charge coupled device (CCD) sensor.

The distance sensor 150 may obtain depth information of an object by capturing the stereo image of the object or by detecting (e.g., by optical signal or wireless signal) the time of flight (ToF) of the object.

The display 160 may form a virtual image on retina of the person wearing the HMD 100.

The HMD 200 may include a processor 210, a storage medium 220, a transceiver 230, a camera 240, and a display 260. In one embodiment, the HMD 200 may further include a distance sensor 250. The processor 210 may be, for example, a CPU or other programmable MCU for general purpose or special purpose, a microprocessor, a DSP, a programmable controller, an ASIC, a GPU, an ALU, a CPLD, a FPGA, or other similar device or a combination of the above devices. The processor 210 may be coupled to the storage medium 220, the transceiver 230, the camera 240, the distance sensor 250, and the display 260.

The storage medium 220 may be, for example, any type of fixed or removable RAM, a ROM, a flash memory, a HDD, an SSD or similar element, or a combination thereof, configured to record a plurality of modules or various applications executable by the processor 210.

The transceiver 230 may be configured to transmit or receive wired or wireless signals. The transceiver 230 may also perform operations such as low noise amplifying, impedance matching, frequency mixing, up or down frequency conversion, filtering, amplifying, and so forth. The HMD 200 may communicate with the HMD 100 or HMD 300 via the transceiver 230.

The camera 240 may be a photographic device for capturing images. The camera 240 may include an image sensor such as a CMOS sensor or a CCD sensor.

The distance sensor 250 may obtain depth information of an object by capturing the stereo image of the object or by detecting (e.g., by optical signal or wireless signal) the time of flight of the object.

The display 260 may form a virtual image on retina of the person wearing the HMD 100.

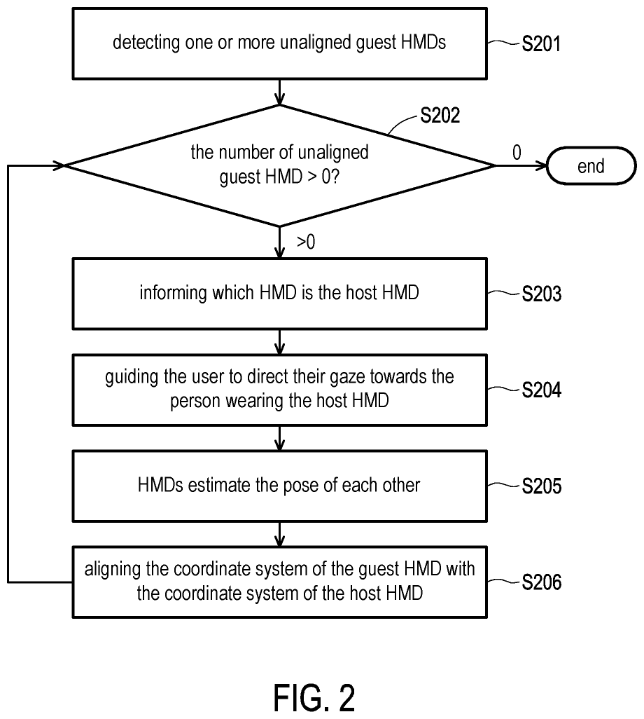

FIG. 2 illustrates a flowchart of a method of coordinate system alignment for multiple HMDs according to one embodiment of the present invention, wherein the method may be implemented by the system 10 as shown in FIG. 1.

In step S201, the host HMD (i.e., HMD 100) may detect one or more unaligned guest HMDs (i.e., HMD 200 or HMD 300). In one embodiment, the HMD 100 may detect the HMD 200 (or HMD 300) by communicating with the HMD 200 via the transceiver 130.

In step S202, the host HMD (i.e., HMD 100) may determine whether the number of unaligned guest HMD is greater than 0. If the number of unaligned guest HMD is greater than 0, than proceeding to step S203. If the number of unaligned guest HMD is equal to 0, stop the execution process of the method.

In step S203, the system 10 may inform the guest HMD (i.e., HMD 200) which HMD is the host HMD (i.e., HMD 100). In one embodiment, the identity of host HMD or guest HMD may be pre-stored in the storage medium 120 of the HMD 100 or the storage medium 220 of the HMD 200. In one embodiment, the identity of host HMD or guest HMD may be determined according to a command input by a user. For example, an HMD (e.g., HMD 100, 200, or 300) may communicate with an input device (e.g., a keyboard, a touch screen, a camera, or a virtual keyboard in a virtual scene displayed by a HMD) via a transceiver of the HMD. The user may manipulate the input device to transmit a command to the HMD.

In step S204, the HMD 200 (or HMD 300) may guide the user of the HMD 200 to direct their gaze towards the person wearing the HMD 100 such that the HMD 200 may capture an image of the person wearing the HMD 100. For example, the HMD 200 may show the user a text message by the display 260 to direct the user's gaze towards the person wearing the HMD 100.

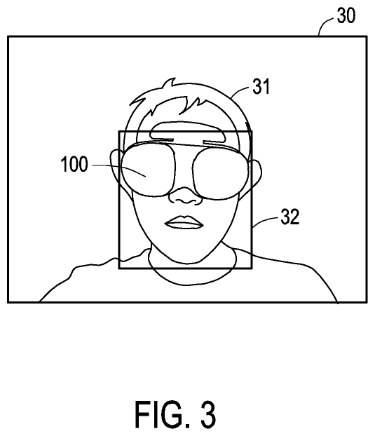

In step S205, the HMDs (i.e., HMD 100, 200, or 300) may estimate the pose of each other. Specifically, the HMD 200 may capture an image of the person wearing the HMD 100 by the camera 240, and may perform face detection on the image to obtain a bounding box corresponding to the coordinate system of the HMD 200. FIG. 3 illustrates a schematic diagram of face detection according to one embodiment of the present invention. The HMD 200 may capture the image 300, wherein the image 300 may include the HMD 100 and the person 31 wearing the HMD 100. The HMD 200 may perform face detection on the image 30 to obtain the bounding box 32 of the face of the person 31, wherein the bounding box 32 may correspond to the coordinate system (e.g., world coordinate system, camera coordinate system, or pixel coordinate system) of the HMD 200 (or camera 240).

In one embodiment, the HMD 200 may obtain depth information of the bounding box 32 by the camera 240 or distance sensor 250. After that, the HMD 200 may calculate the position of the bounding box 32 according to the depth information and the bounding box 32, as shown in equation (1), wherein [x_{w} y_{w} z_{w} 1] is a 3D pose or position of the HMD 100 (or coordinate of the bounding box 32) in a world coordinate system, z_{c} is the depth information of the HMD 100 (or bounding box 32), I⁻¹ is the extrinsic matrix for converting the coordinate of bounding box 32 from the camera coordinate system of the HMD 200 to the world coordinate system, K⁻¹ is the intrinsic matrix for converting the coordinate of the bounding box 32 from the pixel coordinate system to the camera coordinate system of the HMD 200, Ry is a rotation matrix, T_{I} is a translation matrix, and [u v] is a 2D pose or position of the HMD 100 (or coordinate of the bounding box 32) in a pixel coordinate system. In one embodiment, the intrinsic matrix K or the extrinsic matrix I may be pre-configured to the HMD 200 or pre-stored in the storage medium 220. In one embodiment, the HMD 200 may capture a plurality of images by the camera 240 and may perform simultaneous localization and mapping (SLAM) algorithm according to the plurality of images to obtain the extrinsic matrix I.

$$[ \begin{matrix}{x}_{w} \\ {y}_{w} \\ {z}_{w} \\ 1\end{matrix} ] = {z}_{c} \cdot {I}^{- 1} \cdot {K}^{- 1} \cdot [ \begin{matrix}u \\ v \\ 1\end{matrix} ] , I = [ \begin{matrix}{R}_{I} & {T}_{I} \\ 0 & 1\end{matrix} ] \qquad ( 1 )$$

On the other hand, the HMD 100 may capture an image of the person wearing the HMD 200 by the camera 140, and may perform face detection on the image to obtain a bounding box corresponding to the coordinate system of the HMD 100. The HMD 100 may also obtain depth information of the bounding box by the camera 140 or distance sensor 150. The HMD 100 may calculate the position of the bounding box in the coordinate system of the HMD 100 according to the depth information of the bounding box, similar to the manner described by equation (1).

In step S206, the guest HMD (i.e., HMD 200) may align the coordinate system of the guest HMD with the coordinate system of the host HMD (i.e., HMD 100) according to the 3D pose of the host HMD estimated by the guest HMD and the information received from the host HMD, so as to update the coordinate system of the guest HMD. The HMD 200 may display an output image (i.e., rendered image generated by the HMD 200) via the display 260 according to the updated coordinate system of the HMD 200.

Specifically, the HMD 100 may transmit information to the HMD 200, wherein the information may include a difference between the position of the HMD 200 estimated by the HMD 100 and the position of the HMD 100. After the HMD 200 receive the information from the HMD 100, the HMD 200 may align the coordinate system of the HMD 200 to the coordinate system of the HMD 100 according to the position of the HMD 100 estimated by the HMD 200, the position of the HMD 200 estimated by the HMD 200, and the information received from the HMD 100, as shown in equations (2)˜(7), wherein Pₕ(g) is the position of the HMD 200 estimated by the HMD 100 (i.e., a position of HMD 200 corresponds to the world coordinate system of the HMD 100), Pₕ(h) is the position of the HMD 100 estimated by the HMD 100 (i.e., a position of HMD 100 corresponds to the world coordinate system of the HMD 100), P_{g}(g) is the position of the HMD 200 estimated by the HMD 200 (i.e., a position of HMD 200 corresponds to the world coordinate system of HMD 200), P_{g}(h) (i.e., [x_{w} y_{w} z_{w} 1] as shown in equation (1)) is the position of the HMD 100 estimated by the HMD 200 (i.e., a position of HMD 100 corresponds to the world coordinate system of HMD 200), T is a translation matrix, and R is a rotation matrix. The HMD 200 may align the coordinate system of the HMD 200 with the coordinate system of the HMD 100 according to the translation matrix T and the rotation matrix R as shown in equations (6)-(7), so as to update the coordinate system of the HMD 200.

$${V}_{h} = [ {x}_{{V}_{h}} , {y}_{{V}_{h}} , {z}_{{V}_{h}} ] = {P}_{h} ( g ) - {P}_{h} ( h ) \qquad ( 2 )$$

$${V}_{g} = [ {x}_{{V}_{g}} , {y}_{{V}_{g}} , {z}_{{V}_{g}} ] = {P}_{g} ( g ) - {P}_{g} ( h ) \qquad ( 3 )$$

$${P}_{h} ( {g}^{′} ) = {P}_{h} ( h ) + \frac{\vert {V}_{h} \vert + \vert {V}_{g} \vert}{2} \times \frac{{V}_{h}}{\vert {V}_{h} \vert} \qquad ( 4 )$$

$$θ = {cos}^{- 1} ( \frac{( {x}_{{V}_{h}} , 0 , {z}_{{V}_{h}} ) \cdot ( {x}_{{V}_{g}} , 0 , {z}_{{V}_{g}} )}{\vert ( {x}_{{V}_{h ′}} ′ 0 {z}_{{V}_{h}} ) \vert \cdot \vert ( {x}_{{V}_{g}} , 0 , {z}_{{V}_{g}} ) \vert} ) \qquad ( 5 )$$

$$T = {P}_{h} ( {g}^{′} ) - {P}_{g} ( g ) \qquad ( 6 )$$

$$R = [ \begin{matrix}cos θ & 0 & sin θ \\ 0 & 1 & 0 \\ - sin θ & 0 & cos θ\end{matrix} ] \qquad ( 7 )$$

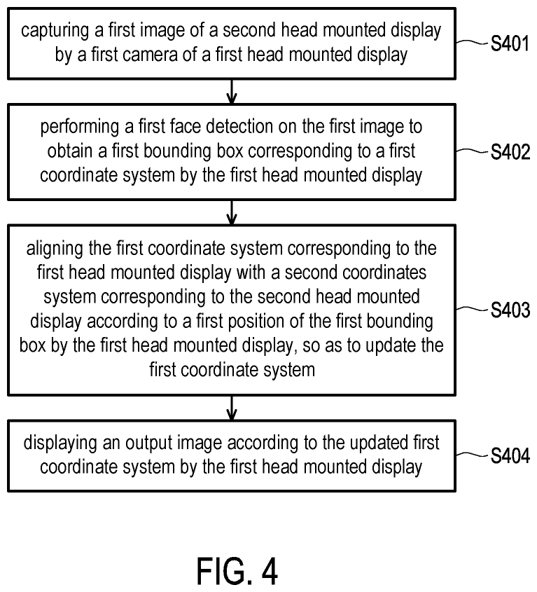

FIG. 4 illustrates a flowchart of a method of coordinate system alignment for multiple HMDs according to one embodiment of the present invention, wherein the method may be implemented by the system 10 as shown in FIG. 1. In step S401, capturing a first image of a second head mounted display by a first camera of a first head mounted display. In step S402, performing a first face detection on the first image to obtain a first bounding box corresponding to a first coordinate system by the first head mounted display. In step S403, aligning the first coordinate system corresponding to the first head mounted display with a second coordinates system corresponding to the second head mounted display according to a first position of the first bounding box by the first head mounted display, so as to update the first coordinate system. In step S404, displaying an output image according to the updated first coordinate system by the first head mounted display.

In summary, the system of the present invention provides a way to align the coordinate systems of multiple HMDs by just gazing each other. A guest HMD may perform a face detection to determine the position of the host HMD, and the guest HMD may align its own camera coordinate system with the camera coordinate system of the host HMD based on the position. For coordinate system alignment, setting a third-party reference object in the field is not required when the present invention is implemented.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A system of coordinate system alignment for multiple head mounted displays, comprising:
a first head mounted display, comprising a first camera; and
a second head mounted display, wherein the first head mounted display is configured to:
capture a first image of the second head mounted display by the first camera;
perform a first face detection on the first image to obtain a first bounding box corresponding to a first coordinate system;
align the first coordinate system corresponding to the first head mounted display with a second coordinate system corresponding to the second head mounted display according to a first position of the first bounding box, so as to update the first coordinate system; and
display an output image according to the updated first coordinate system.

2. The system of claim 1, wherein the second head mounted display comprises a second camera, wherein the second head mounted display is communicatively connected to the first head mounted display and is configured to:
capture a second image of the first head mounted display by the second camera;
perform a second face detection on the second image to obtain a second bounding box corresponding to the second coordinate system; and
transmit information to the first head mounted display, wherein the information is associated with a second position of the second bounding box.

3. The system of claim 2, wherein the first head mounted display aligns the first coordinate system with the second coordinate system according to the information.

4. The system of claim 2, wherein the information comprises a difference between the second position and a third position of the second head mounted display.

5. The system of claim 1, wherein the first head mounted display is further configured to:
obtain a coordinate of the first bounding box; and
calculate the first position according to the coordinate, an inverse matrix of an intrinsic matrix of the first camera, and an inverse matrix of an extrinsic matrix of the first camera.

6. The system of claim 5, wherein the first head mounted display is further configured to:
capture a plurality of images by the first camera; and
perform a simultaneous localization and mapping algorithm according to the plurality of images to obtain the extrinsic matrix.

7. The system of claim 5, wherein the first head mounted display is further configured to:
obtain depth information of the first head mounted display by the first camera; and
calculate the first position according to the depth information.

8. The system of claim 5, wherein the first head mounted display further comprises a distance sensor and the first head mounted display is further configured to:
obtain depth information of the first head mounted display by the distance sensor; and
calculate the first position according to the depth information.

9. A method of coordinate system alignment for multiple head mounted displays comprising:
capturing a first image of a second head mounted display by a first camera of a first head mounted display;
performing a first face detection on the first image to obtain a first bounding box corresponding to a first coordinate system by the first head mounted display;
aligning the first coordinate system corresponding to the first head mounted display with a second coordinates system corresponding to the second head mounted display according to a first position of the first bounding box by the first head mounted display, so as to update the first coordinate system; and
displaying an output image according to the updated first coordinate system by the first head mounted display.

10. The method of claim 9, further comprising:
capturing a second image of the first head mounted display by a second camera of a second head mounted display, wherein the second head mounted display is communicatively connected to the first head mounted display;
performing a second face detection on the second image to obtain a second bounding box corresponding to the second coordinate system by the second head mounted display; and
transmitting information to the first head mounted display by the second head mounted display, wherein the information is associated with a second position of the second bounding box.

11. The method of claim 10, wherein the first head mounted display aligns the first coordinate system with the second coordinate system according to the information.

12. The method of claim 10, wherein the information comprises a difference between the second position and a third position of the second head mounted display.

13. The method of claim 9, further comprising:
obtaining a coordinate of the first bounding box by the first head mounted display; and
calculating the first position according to the coordinate, an inverse matrix of an intrinsic matrix of the first camera, and an inverse matrix of an extrinsic matrix of the first camera by the first head mounted display.

14. The method of claim 13, further comprising:
capturing a plurality of images by the first camera; and
performing a simultaneous localization and mapping algorithm according to the plurality of image to obtain the extrinsic matrix by the first head mounted display.

15. The method of claim 13, further comprising:
obtaining depth information of the first head mounted display by the first camera; and
calculating the first position according to the depth information by the first head mounted display.

16. The method of claim 13, further comprising:
obtaining depth information of the first head mounted display by a distance sensor of the first head mounted display; and
calculating the first position according to the depth information by the first head mounted display.
